(19) United States
(12) Patent Application Publication
(10) Pub. No.: US 2008/0244634 A1
(43) Pub. Date: Oct. 2, 2008

(54) System and Method for Inputting Preferences Into Recommender/Profiling System

(75) Inventors: Markus Gerardus Leonardus Maria Van Doorn, Eindhoven (NL); Ramon Antoine Wiro Clout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC N.V., EINDHOVEN (NL)

(21) Appl. No.: 10/597,319

(22) PCT Filed: Jan. 17, 2005
(86) PCT No.: PCT/IB2005/050196

§ 371 Date: Jul. 20, 2006

Related U.S. Application Data
(60) Provisional application No. 60/537,803, filed on Jan. 20, 2004.

(51) Int. Cl. H04H 60/33; H04N 7/16

(52) U.S. Cl. 725/14

(57) ABSTRACT

A user profiling system that receives user command/control selections related to content currently being provided to the user. A processor acts on the command/control selections and also determines whether the command/control selections are volume related command/control selections. In a case where the command/control selections are volume related, the processor utilizes these volume related command/control selections as an input to a user profile of the user profiling system. The user profile may be utilized for providing recommendations of content to the user.

This invention generally relates to a system and method for inputting user audio/audiovisual preferences into a system. Specifically, the present invention relates to a non-intrusive system for capturing user audio/audiovisual preferences for a recommender/profiling system.

Many systems are known for assisting users to select audio and audiovisual content that the user may be desirous of listening to and/or watching. The problem is greatly simplified when the user knows exactly what audio or audiovisual content the user wants to listen to or watch. In this instance, the user merely needs to select the content explicitly. However, in many instances, the user may desire being presented with content that they may like but are unfamiliar with. This situation is particularly true when a user is presented with large amounts of content to select from.

Systems are known that receive input from a user in the form of implicit and/or explicit input about content that a user likes or dislikes. As an example, co-pending, commonly assigned U.S. patent application Ser. No. 09/466,406, filed Dec. 17, 1999, by Gutta et al., entitled Method and Apparatus for Recommending Television Programming using Decision Trees, incorporated herein by reference as if set out fully herein, discloses an example of an implicit recommender system. These implicit recommender systems recommend content (e.g., television content, audio content, etc.) to a user in response to stored signals indicative of a stored user profile and user viewing/listening history. For example, a television recommender may recommend television content to a viewer based on other television content that the viewer has selected for watching. By analyzing content that was watched previously, the television recommender, determines characteristics of the watched content and then tries to recommend other content having similar characteristics. This process tends to be cumulative in that the more content that the television recommender analyzes (the more television shows that the viewer watches and that the television recommender analyzes), the better the recommendations from the television recommender tend to be. In fact, many television recommender systems work better as more content is analyzed. Many different types of mathematical models are utilized to analyze the implicit data received to determine what a user may want to watch.

Another type of known television recommender system utilizes an explicit profile to determine what a user may want to watch. An explicit profile works similar to a questionnaire wherein the user typically is prompted by a user interface on the television display to answer explicit questions about what types of content the user is likely to watch. Questions may include: what is the genre of content the viewer likes; what actors or producers the viewer likes; whether the viewer likes movies or series; etc. These questions of course can also be more sophisticated as is known in the art. In this way, the explicit television recommender builds a profile of what the viewer explicitly says they like or dislike.

Based on this explicit profile, the explicit recommender will suggest further content that the viewer is likely to also like. For instance, an explicit recommender may receive information that the viewer enjoys John Wayne action movies. From this explicit input, the recommender may recommend a John Wayne movie for viewing. Of course this is a very simplistic example and as would be readily understood by a person of ordinary skill in the art, much more sophisticated analysis and recommendations may be provided by an explicit recommender/profiling system. Other recommender systems are known, for example, co-pending, commonly assigned U.S. patent application Ser. No. 09/666,401, filed Sep. 20, 2000, by Kurapati et al., entitled Method and Apparatus for Generating Recommendation Scores Using Implicit and Explicit Viewing, discloses an example of an implicit and explicit recommender system. U.S. patent application Ser. No. 09/627,139, filed Jul. 27, 2000, by Shaffer et al., entitled Three-way Media Recommendation Method and System, discloses an example of an implicit, explicit and feedback based recommender system. U.S. patent application Ser. No. 09/953,385, filed Sep. 10, 2001, by Shaffer et al., entitled Four-Way Recommendation Method and System Including Collaborative Filtering, discloses an example of an implicit, explicit, feedback and collaborative filtering based recommender system. Each of these systems are incorporated herein by reference as if set out fully herein.

Problems exist in each of these systems in that they are limited in what is examined for determining both implicit and explicit profile data.

Accordingly, it is an object of the present invention to overcome the disadvantages of the prior art and provide additional data that may be analyzed by a recommender/profiling system.

The present invention is a user profiling system that receives user command/control selections related to content currently being provided to the user. A processor acts on the command/control selections and also determines whether the command/control selections are volume related command/control selections. In a case where the command/control selections are volume related, the processor utilizes these volume related command/control selections as an input to a user profile of the user profiling system.

In one embodiment, the processor identifies a previously established volume level of reproduced content and compares the identified volume related command/control selections to the previously established volume level. In effect, a command/control selection to increase the volume of currently reproduced content may be interpreted by the profiling system as an indication that the user likes the currently reproduced content. In the same way, a command/control selection to decrease the volume of currently reproduced content may be interpreted by the profiling system as an indication that the user dislikes the currently reproduced content.

The profiling system may include a remote control device where the user may input the command/control selection, and a memory coupled to the processor for storing the user profile. The profiling system may be part of a content recommender system for recommending content to the user based on content previously reproduced for the user.

The following are descriptions of embodiments of the present invention that when taken in conjunction with the following drawings will illustrate one or more of the above noted features and advantages, as well as further ones. It should be expressly understood that the drawings are included for illustrative purposes and do not represent the scope of the present invention that is defined by the appended claims. The invention is best understood in conjunction with the accompanying drawings in which:

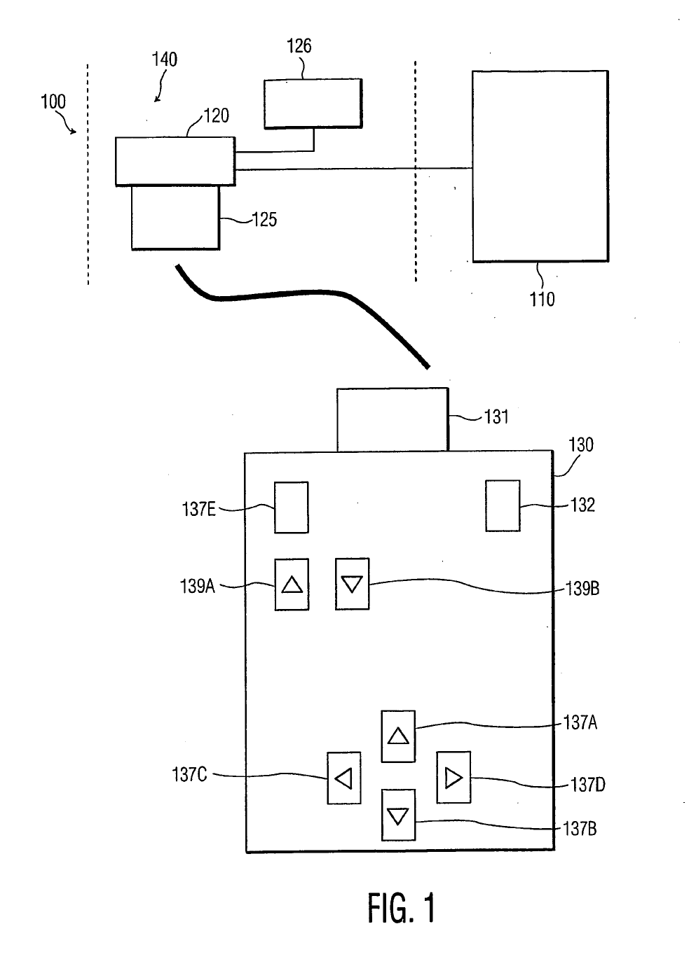

FIG. 1 shows an illustrative system in accordance with an embodiment of the present invention; and

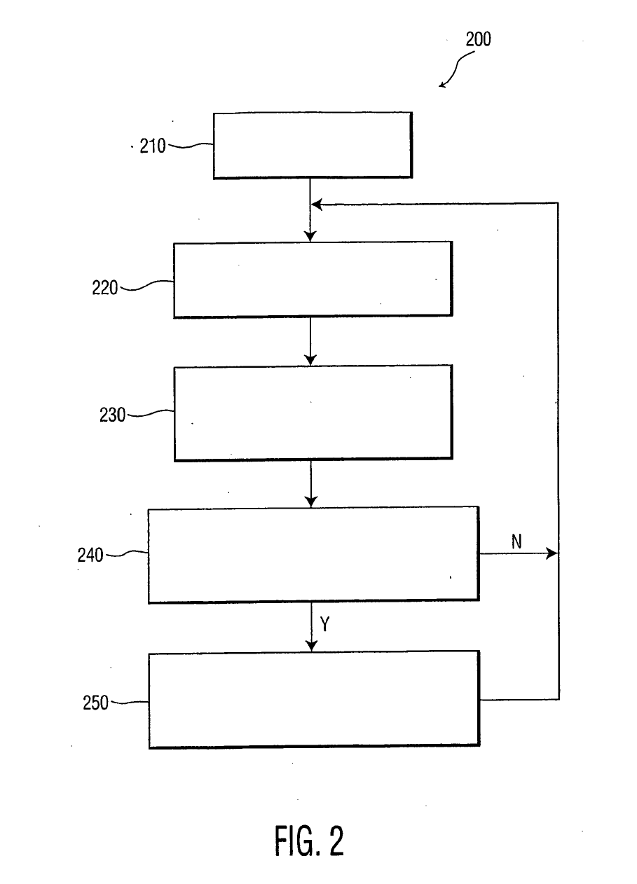

FIG. 2 shows a flow diagram illustrating an operation in accordance with an embodiment of the present invention.

In the discussion to follow, certain terms will be illustratively discussed in regard to specific embodiments or systems to facilitate the discussion. As would be readily apparent to a person of ordinary skill in the art, these terms should be understood to encompass other similar known terms wherein the present invention may be readily applied. For example, the present invention will illustratively be described with regard to audio/visual content. This system would obviously also be applicable to strictly audio content or a mixture of audio and other types of content. Each of these and any other applicable system should be understood to be within the scope of the appended claims.

FIG. 1 shows an illustrative system 100 in accordance with an embodiment of the present invention including an output 110, operatively coupled to a processor 120, and a remote control device 130. The processor 120 and the remote control device 130 are operatively coupled as is known in the art. This coupling is illustratively shown, via an infrared (IR) receiver 125, operatively coupled to the processor 120, and an IR transmitter 131, operatively coupled to the remote control device 130. As would be readily appreciated, other forms of coupling may also be utilized, including but not limited to other wireless couplings such as radio frequency (RF) coupling, wired coupling, or any other coupling that enables the devices to operate in accordance with the present invention.

The output 110 may illustratively be an audio/visual output such as a television or other device enabled to reproduce audiovisual content for a user. The processor 120 is operatively coupled to a memory 126 for use by the processor 120 to store user profile data in accordance with the present invention. As is known, the memory 126 may store profile data on the user for the purposes of providing the user with suggested content. Accordingly, it should be understood that the processor 120 is enabled for creating and or updating the profile for the user and for operation in receiving commands from the remote control 130. To this end, the processor 120 may utilize either or both of an implicit and explicit recommendation scheme as is known in the art.

In receiving commands from the remote control 130, the processor is also enabled for acting on a command received as discussed further herein below. The processor 120, IR receiver 125, and memory 126 together make up a profiling (and recommender) system 140. Other components may also be utilized in this system as is known in the art.

The remote control device 130 may contain selector buttons that operate as is known in the art. Specifically, the remote control device 130 may contain numerous user selector buttons 137A, 137B, 137C, 137D, 137E and 132. These buttons may be content selector buttons, configuration control buttons, etc. For example, button 132 may be a power on/off selector so that the user may turn on/off the output 110 and/or the coupled profiling system 140. The remote control 130 may also contain other control buttons, such as volume control buttons 139A, 139B for selecting the volume of reproduced content by the output 110.

In ordinary operation, processor 120 receives commands from the user as a result of the user manipulating the volume selector buttons 139A, 139B. The manipulation of the volume selector buttons 139A, 139B causes the processor 120 to initiate either of an increase or decrease in the reproduced volume of content as is known.

In accordance with the present invention, the manipulation of the volume selector buttons 139A, 139B is also analyzed by the processor 120 for the purposes of capturing implicit profiling information about the user. For example, in accordance with the present invention, the processor 120 may interpret the user selection of an increase in volume of reproduced content as an indication that the current content is enjoyed by the user. The processor 120 may interpret the user selection of a decrease in volume of reproduced content as an indication that the current content is not enjoyed by the user. These indications may then be fed into the profiling system 140 as implicit indications of the user's preferences. The processor 120 may utilize these indications, together with information on the content (e.g., identification of content, content genre, content performers, etc.) as input to an implicit profile for the user. This profile either alone or together with other profile data may then or thereafter be utilized for recommending further content to the user.

Further operation of the present invention will be illustrated with reference to FIG. 2 that shows a flow diagram 200 in accordance with the present invention and previously discussed FIG. 1. Specifically, during act 210 the system 100 reproduces content (e.g., plays audio content) for a user via output 110. This content is reproduced at a volume that is previously established, for example, by a user previous volume selection Thereafter, during act 220, the processor 120 awaits for receipt of a user command/control function, for example via the remote control 130. After a user command/control function is received, during act 230 the processor 120 performs an ordinary function (e.g., volume up/down, channel change, etc.) in accordance with the received command/control function. This ordinary function may also include providing a user with recommendations for content based on a stored user profile. After the processor performs the user selected function, during act 240, the processor 120 determines whether the received command/control function was a volume selection related command/control function. In the event that the received command/control function was not a volume selection related command/control function, then the processor returns to act 220 to await receipt of further user command/control functions.

However, if the received command/control function was a volume selection related command/control function, during act 250 the processor 120 analyzes the received command/control function for use as input into the profiling system. For example, if the received command/control function was a command to increase the volume of reproduced content, the processor may use this as an indication that the currently reproduced content is liked by the user and this information may be input into a stored implicit profile (e.g., stored in memory 126) for the user. If the received command/control function was a command to decrease the volume of reproduced content, the processor may use this as an indication that the currently reproduced content is not liked by the user and this information may be input into the stored implicit profile for the user. The processor 120 may also use as input for the profiling system the amount of volume increase or decrease for the currently reproduced content.

Illustratively, in one embodiment of the present invention a default volume level of a song (for comparison with any volume up/down commands given by the user) may be deduced using a statistical function from past interaction. For example, one heuristic might be to take the average value of the volume level over a given period of time. This may be further qualified specifically for a given genre of content. Illustratively, once this default is established, the profiling system 140 may monitor how much the user deviates from this default level when listening to particular content or content of the current genre.

Another heuristic may also take a frequency of volume up/down presses into account. In this, for example, two volume up commands for a given presented content may increase the probability that the user finds the content more interesting than if only one or no volume up commands were given. The frequency may need to be normalized by how often the user gives volume up/down commands. This may assist to compensate for things, such as, noisy environments, people with hearing problems, other external factors, etc.

More sophisticated algorithms may also trace other remote control commands, together with volume control commands, to deduce feedback from those commands, including in combination with volume up/down commands. For example, “next” and “previous” commands, may also provide information for use in an implicit profiler. For example, a “Previous” command followed by “volume up” (2 times) indicates that the user wants to listen to the same song again and at a higher volume level. This is a strong indication that this may be content that the user likes.

All this implicit information may be utilized by the processor 120 for providing a future recommendation of content at the request of the user (e.g., during act 220). As should be readily understood, the indication of preferences in accordance with the present invention (e.g., volume selection) may be utilized alone or together with other known profile data for providing the recommendation to the user.

Finally, the above-discussion is intended to be merely illustrative of the present invention. Numerous alternative embodiments may be devised by those having ordinary skill in the art without departing from the spirit and scope of the following claims. For example, although the processor 120 is shown separate from the output 110, clearly both may be combined in a single device such as a television. In addition, the processor 120 may be a dedicated processor for performing in accordance with the present invention or may be a general purpose processor wherein only one of many functions operates for performing in accordance with the present invention. In addition, the processor may operate utilizing a program portion, multiple program segments, or may be a hardware device utilizing a dedicated or multi-purpose integrated circuit.

Further, although the volume selector buttons 139A, 139B are shown on the remote control device 130, there is no real need for the volume selector buttons 139A, 139B to be on a separate device than the processor 120, for example. Clearly the location or configuration of volume selector buttons 139A, 139B should not be understood to be a limitation on the following claims unless explicitly stated therein. For example, instead of volume up/down buttons, a jog dial button or any other user interface or mechanism may be utilized to provide volume control feedback to the profiling system 140.

In this or other embodiments, profiling system 140, including or simply the processor 120 may be located remotely via, for example, the Internet or some other server one a network, such as a (wireless) home network. As a person of ordinary skill in the art would appreciate, the profiling system 140 does not have to be necessarily located locally. For example, in one embodiment, volume up/down commands received by an internet radio from a remote control may be forwarded to a server on the internet or in the home that does the comparison.

Numerous alternative embodiments may be devised by those having ordinary skill in the art without departing from the spirit and scope of the following claims. In interpreting the appended claims, it should be understood that:

a) the word “comprising” does not exclude the presence of other elements or acts than those listed in a given claim;

b) the words “a”; “an”; “the”; etc. preceding an element does not exclude the presence of a plurality of such elements;

c) any reference signs in the claims do not limit their scope; and

d) several “means” may be represented by the same item or hardware or software implemented structure or function

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated

The claimed invention is:

1. A user profiling system comprising:
a user input device configured to enable a user to input user command/control selections;
a processor operatively coupled to the user input device and configured to receive the user command/control selections, wherein the processor is configured to identify volume related command/control selections and to utilize identified volume related command/control selections as an input into a user profile.

2. The profiling system of claim 1, wherein the processor is configured to identify a previously established volume level of reproduced content and to compare the identified volume related command/control selections to the previously established volume level.

3. The profiling system of claim 1, comprising a remote control device having the user input device.

4. The profiling system of claim 1, comprising a memory operatively coupled to the processor and configured to store the user profile.

5. The profiling system of claim 1, comprising a memory operatively coupled to the processor and configured to store the user profile, wherein the processor is configured to provide recommendation of content based on the stored user profile.

6. The profiling system of claim 5, wherein the processor is configured to provide recommendations of content comprising at least one of audio and audiovisual content.

7. A method of determining user profile data for a profiling system, the method comprising:
receiving a user command/control selection;
determining whether the received user command/control selection is a volume related command/control selection;
storing profile data related to the received user command/control selection if the received user command/control selection is a volume related command/control selection.

8. A program portion stored on a processor readable medium for use with a user profiling system, the program portion comprising:
a program segment for analyzing received user command/control selections relating to currently reproduced content;
a program segment for determining whether the received user command/control selection is a volume related command/control selection; and
a program segment for initiating a storing of profile data related to the received user command/control selection if the received user command/control selection is a volume related command/control selection.

9. The program portion of claim 8, wherein the program segment for initiating the storing of profile data related to the received user command/control selection comprises a program segment for initiating storing of data indicating a user preference if the received user command/control selection is a volume increase related command/control selection.

10. The program portion of claim 8, further comprising a program segment for providing recommendation of content based on the stored user profile.
